(19) United States
(12) Patent Application Publication
(10) Pub. No.: US 2017/0344232 A1
(43) Pub. Date: Nov. 30, 2017

(54) USER INTERFACE FOR SEARCHING AND CLASSIFYING BASED ON EMOTIONAL CHARACTERISTICS

(71) Applicant: Paratype Ltd., Saratoga, CA (US)

(72) Inventors: Artem DRABKIN, Moscow (RU); Alexey NAUMENKOV, Brooklyn, NY (US)

(21) Appl. No.: 15/169,128

(22) Filed: May 31, 2016

(51) Int. Cl. G06F 3/0484; G06F 17/30

(52) U.S. Cl. CPC G06F 3/04845; G06F 17/30713; G06F 3/04847; G06F 17/30657

(57) ABSTRACT

Emotional characteristic based searching is described. A method may include providing, for display on a graphical user interface (GUI), emotional characteristic indicator pairs and interface elements, each of the interface elements being associated with an emotional characteristic indicator pair. The method may further include receiving first user input selecting, via a first interface element of the GUI, a desired level of first emotion from emotions represented by a first pair of the emotional characteristic indicator pairs and receiving second user input selecting, via a second interface element of the GUI, a desired level of second emotion from emotions represented by a second pair of the emotional characteristic indicator pairs. In response to the first user input and the second user input, the method may further include providing one or more items corresponding to the desired level of first emotion and the desired level of second emotion.

### TECHNICAL FIELD

This disclosure relates to the field of searching for and classifying items and, in particular, to searching for and classifying items based on emotional characteristics.

### BACKGROUND

As the amount of information on the internet continues to exponentially grow, so does the usefulness of methods for searching and classifying the information. Traditional searching methods search for items based on a string of text (a query). Traditional searching methods are also limited to searching for whether a provided characteristic, represented by the query, is present; they do not allow a user to search for, classify, and differentiate between items that are associated with varying levels of a particular characteristic.

### BRIEF DESCRIPTION OF THE DRAWINGS

The present disclosure will be understood more fully from the detailed description given below and from the accompanying drawings of various embodiments of the present disclosure, which, however, should not be taken to limit the present disclosure to the specific embodiments, but are for explanation and understanding only.

FIG. 1 is a block diagram illustrating an exemplary network architecture in which embodiments of the present disclosure may be implemented.

FIG. 2 is a block diagram illustrating an emotional characteristic search unit, according to an implementation.

FIG. 3 is a flow diagram illustrating a method for an emotional characteristic search, according to an implementation.

FIG. 4 is a flow diagram illustrating a method for ranking search results of an emotional characteristic search, according to an implementation.

FIG. 5 is a flow diagram illustrating a method for modifying emotional characteristic indicator pair values, according to an implementation.

FIG. 6 is a block diagram illustrating an emotional characteristic search user interface, according to an implementation.

FIG. 7 is a block diagram of an example computing device, according to an implementation.

### DETAILED DESCRIPTION

Aspects of the disclosure provide a user interface to search for and classify items based on emotional characteristics. In an illustrative embodiment, a search for items is performed based on emotional characteristics provided via a graphical user interface (GUI). The GUI may be displayed to a user requesting a search. In one embodiment, the GUI assists a user search for one or more items based on a defined number of emotional characteristics. For example, a user may wish to locate a particular font for a document, where the font is associated with masculine, happy, and youthful characteristics. Furthermore, the user may wish to locate a particular font with specific levels of the masculine, happy, and youthful characteristics. Aspects of the disclosure provide to the user a masculine, happy, and youthful font with the desired characteristic levels.

In one embodiment, the GUI displays emotional characteristic indicator pairs, from which a user may select varying levels of each emotional characteristic of a pair. For example, the GUI may display three emotional characteristic pair indicators. In particular, the GUI may display a first pair of images (e.g., the first of a woman and the second of a man) to represent a femininity-masculinity characteristic. Likewise, the GUI may also display an image of a frowning person next to an image of a smiling person to represent a sad-happy characteristic pair. Lastly, the GUI may display an image of a young child with an image of an elderly person to represent a young-old characteristic. In another embodiment, the emotional characteristic pair indicators may be textual descriptions.

The GUI may display each emotional characteristic indicator pair with associated GUI elements that allow a user to select a desired level of each characteristic, where each element is associated with a single pair. The GUI elements may be, for example, sliders that can be activated to set a desired level. It should also be noted that the interface element may also be in the form of a text box, buttons, or any other interactive GUI element that allows a user to provide an input.

A user may slide the interface element along a scale (e.g., 1-100), where one end of the scale represents 100% of one of an emotional characteristic represented by the associated indicator pair and the opposite end of the scale represents 100% of the other emotional characteristic of the pair. For example, if a user wishes to search for a font that is 100% feminine, the user may slide the interface element completely to the side of the scale that represents femininity. Alternatively, the user may slide the element completely to the other side of the scale, which represents 100% masculinity.

The user may also search for items that have a level of femininity or masculinity between the two extremes. For example, a user may search for a 50% feminine and 50% masculine font by sliding the interface element to the middle of the scale. Any other combination of levels of emotional characteristics is possible by adjusting the interface element. The GUI may also display a representation of the currently selected level of an emotional characteristic. For example, as a user slides an interface element from the femininity extreme to the masculinity extreme, the GUI may change the image representing a currently selected level of femininity versus masculinity by dynamically shifting from depicting a very feminine woman, to depicting a less feminine woman, to depicting a less masculine man, and finally to depicting a very masculine man.

The user may search for the desired font by selecting levels for more than one of the presented emotional characteristic indicator pairs, and the GUI can then present search results based on the multiple selected emotional characteristics.

Aspects of the present disclosure allow a user to search for items based on a plurality of emotional characteristics. Furthermore, aspects of the present disclosure identify search results based on selected levels of emotional characteristics, instead of identifying search results based solely on whether a desired emotional characteristic is present.

While embodiments may be described in relation to certain items (e.g., fonts), in alternative embodiments, the methods and apparatus discussed herein may also be used to search for other types of items (e.g., images, audio and video content, text content, websites, etc.). For example, in alternative embodiments, the methods described herein could be used to search the Internet for any types or any combinations of types of items associated with selected characteristics.

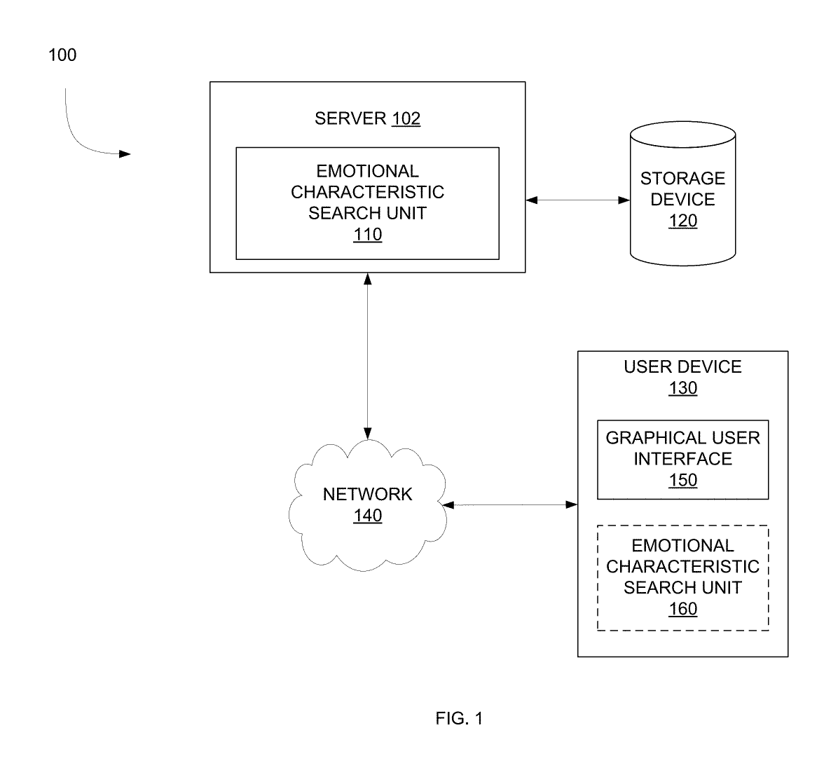

FIG. 1 is a block diagram illustrating an exemplary network architecture in which embodiments of the present disclosure may be implemented. The network architecture 100 may include one or more servers 102 communicating with one or more user devices 130 over one or more networks 140, according to one embodiment. Network 140 can be a local area network (LAN), a wireless network, a telephone network, a mobile communications network, a wide area network (WAN), such as the Internet, or similar communication system. User devices 130 may be any type of computing device including server computers, gateway computers, desktop computers, laptop computers, game consoles, mobile communications devices, cell phones, smart phones, hand-held computers, tablets, smart TVs, set-top boxes, or similar computing devices. The user devices 130 may be variously configured with different features to enable viewing of visual content, such as images, videos, etc.

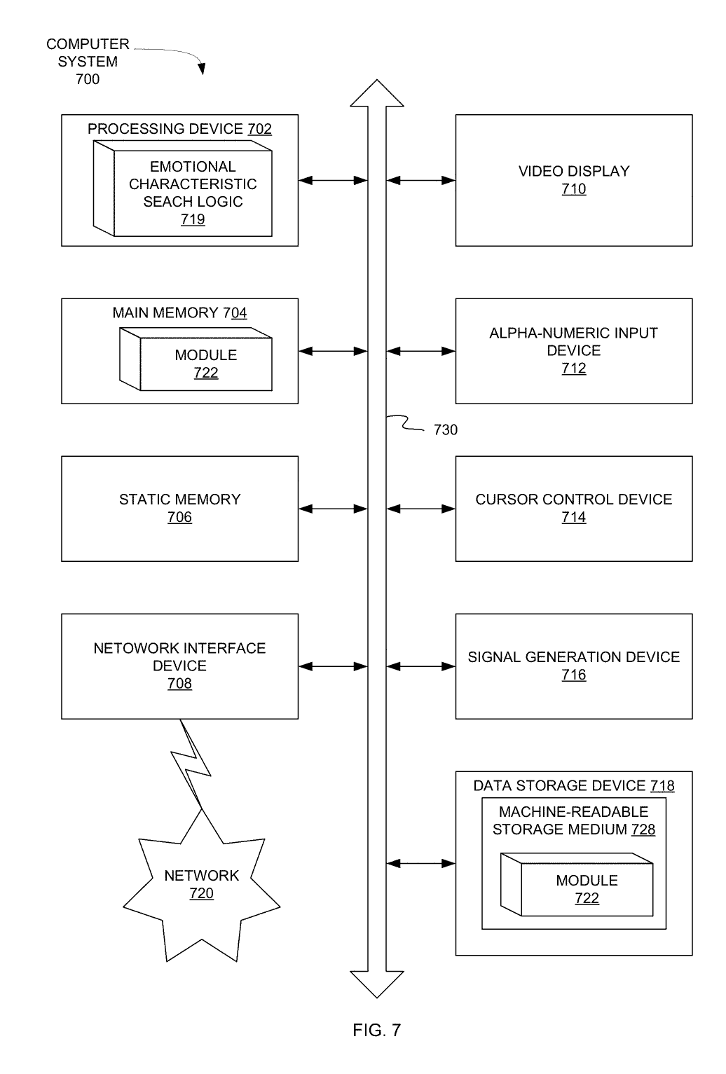

Server 102 may include a network-accessible server-based functionality, various data stores, and/or other data processing equipment. The server 102 may be implemented by a single machine or a cluster of machines. Server 102 may include, for example, computer system 700 of FIG. 7. In one embodiment, server 102 includes emotional characteristic search unit 110. Emotional characteristic search unit 110 can receive a connection from a user device 130 and can also send data to user device 130. Upon connecting to a user device 130, the emotional characteristic search unit 110 can perform searches from all user devices 130 connected to server 102. In one embodiment, when a first user connects a first user device 130 to server 102 and a second user connects a second user device to server 102, server 102 may be the same server which handles both users' connections. In another embodiment, when a first user connects a first user device 130 to server 102 and a second user connects a second user device to server 102, server 102 may represent different servers, so that each user connects to a different server. In another embodiment, user device 130 may include emotional characteristic search unit 160, which may perform the functions described with respect to emotional characteristic search unit 110. Advantageously, user device 130 with included emotional characteristic search unit 160 may allow for item classification and search via GUI 150, without connecting to server 102 and/or emotional characteristic search unit 110.

In one embodiment, storage device 120 includes data store 222, which may store emotional characteristic indicator pairs, interface elements, and items that may be shown as search results. In response to a request from a user (e.g., received through one of user devices 130), emotional characteristic search unit 110 can provide a GUI 150 to perform a search based on emotional characteristics and initiate the search when appropriate selections have been received. GUI 150 can be rendered in a web browser hosted by user device 130. Alternatively, GUI 150 can be provided by a mobile application hosted by user device 103 and associated with server 102.

Storage device 120 may be part of the same machine as server 102 or may be external to server 102 and may be connected to server 102 over a network or other connection. Storage device 120 may include one or more mass storage devices which can include, for example, flash memory, magnetic or optical disks, or tape drives, read-only memory (ROM); random-access memory (RAM); erasable programmable memory (e.g., EPROM and EEPROM); flash memory; or any other type of storage medium.

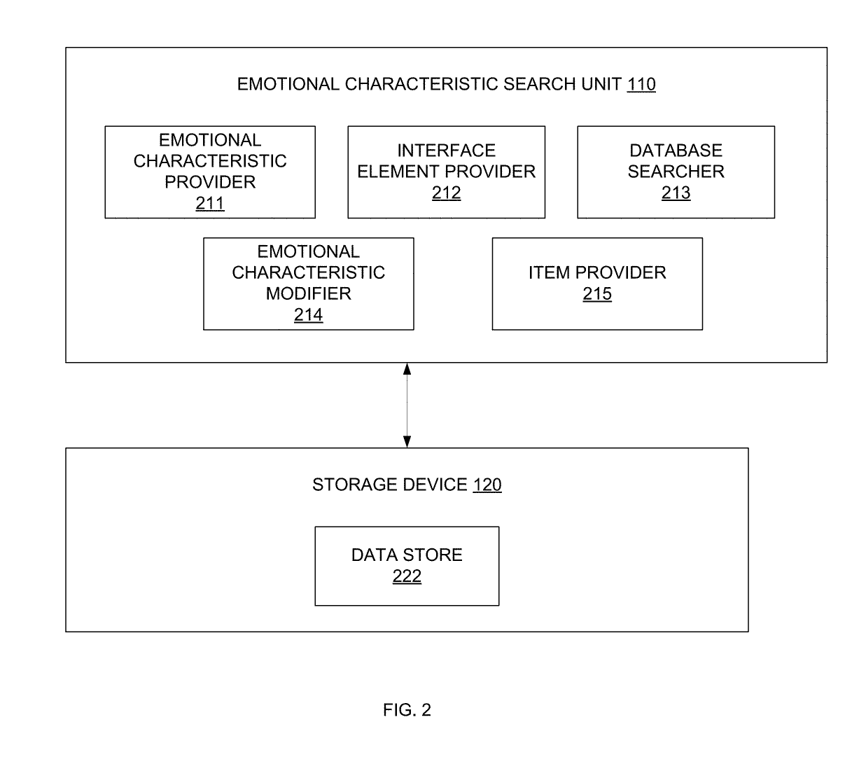

FIG. 2 is a block diagram illustrating an emotional characteristic search unit, according to an implementation. In one embodiment, emotional characteristic search unit 110 may include emotional characteristic provider 211, interface element provider 212, database searcher 213, emotional characteristic modifier 214, and item provider 215. This arrangement of modules may be a logical separation, and in other embodiments, these modules or other components can be combined together or separated in further components, according to a particular embodiment. In one embodiment, emotional characteristic search unit 110 maintains data store 222 hosted by storage device 102. Emotional characteristic search unit 110 can receive a connection from a user device 130, and provide a search GUI and initiate a search based on emotional characteristics selected by a user via the search GUI.

In one embodiment, emotional characteristic provider 211, interface element provider 212, database searcher 213, emotional characteristic modifier 214, and item provider 215 are used to perform a search utilizing data stored in data store 222. Data store 222 may store, for example, emotional characteristic indicators, interface elements, and items to be searched. In one embodiment, data store 222 may also include emotional characteristic levels that are associated with each of the items stored in data store 222 or in another data store. In one embodiment, data store 222 may include a lookup table or other data structure for storing information.

In one embodiment, emotional characteristic provider 211 may provide emotional characteristic indicator pairs for a graphical user interface. The emotional characteristic indicators may be images that depict a particular characteristic. Emotional characteristic indicators may also be textual, or may be in any other form that represents the emotional characteristics depicted. Emotional characteristics may be displayed in opposing pairs. For example, a happy indicator may be displayed with a sad indicator. Any characteristic may be provided by emotional characteristic provider 211.

Characteristic pairs may include, for example: feminine-masculine, happy-sad, introvert-extravert, natural-artificial, nontraditional-traditional, healthy-unhealthy, and formal-informal. As a user interacts with an interface element to adjust levels of a particular characteristic pair, emotional characteristic provider 211 may also provide an image representing the current level of the characteristic pair. For example, if a user selects a level of 50% happy and 50% sad, the image may display a neutral face, i.e. a face that is both 50% happy and 50% sad so that the user may visualize his or her current selection. Emotional characteristic provider 211 may provide numerous emotional characteristic pairs on the same GUI.

Interface element provider 212 may provide interface elements that are associated with the emotional characteristic pairs. Interface elements may allow a user to select a desired level each characteristic provided by emotional characteristic provider 211. In one embodiment, the interface element is a slider interface element that allows a user to drag a slider along a scale from one characteristic of a pair to the other. As the user adjusts the interface element and thereby adjusts the level of a particular emotional characteristic selected, an image may be dynamically (substantially immediately in response to the user adjustment) modified to represent the new level of that emotional characteristic currently selected. In other embodiments, the interface element may be a text box, button, or any other actionable GUI element.

Database searcher 213 may search a database for items that are associated with the particular levels of emotional characteristics selected by a user. In one example, a user may search for an item with a happy-sad level of 25, indicating that the item should be primarily happy (about 75%) but also have a sad component (about 25%). The user may also indicate that the item should have a femininity-masculinity level of 75%, indicating that the item should be primarily masculine (about 75%) but also have a feminine component (about 25%). Database searcher 213 searches a database for items that most closely match the desired levels of the characteristics selected. Once identified, search results may be ranked according to how closely they correspond to the desired levels, and provided to the user based on the rankings. In one embodiment, the search results that are most relevant (e.g., most closely match the desired levels) are displayed above the search results that are less relevant.

Items in the database may have emotional characteristic levels assigned to them. For example, an image in the database may have a happy-sad level of 25, femininity-masculinity level of 75, and an introvert-extravert level of 50. If a user searches for an item with those exact levels of characteristics, the item described above may be determined extremely relevant and be displayed at the top of the search results list. If the user instead searches for an item with a happy-sad level of 30, femininity-masculinity level of 60, and an introvert-extravert level of 40, the item described above may be determined to be less relevant than other items found (whose characteristic levels more closely match the desired levels).

Items in the database may originally be associated with particular levels of characteristics by experts. Alternatively, or in combination, machine learning algorithms may determine characteristic levels of items in a database. The database may be a local database associated with a GUI for emotional characteristic based searches, or it may be a network database including web pages and other storage structures on the Internet. For example, a local database may be a database containing document fonts, where the database is not available via the Internet. Such a database may be accessed and searched via a native application. Alternatively, a networked database may include any database that can be accessed from the internet. A networked database may be accessed and searched via a native application, a web application, a website, or via any other means of connecting to and performing search operations on a database.

Emotional characteristic modifier 214 may adjust levels of emotional characteristics associated with items in a database. The level adjustment by emotional characteristic modifier 214 may be understood as a classification, or reclassification, of items in the database. In one embodiment, when items are displayed to a user as search results, the user may be presented with an option to adjust emotional characteristic levels of an item. For example, a user may think that an item is mostly masculine, but the current femininity-masculinity level associated with the item is mostly feminine. The user may adjust the femininity-masculinity level to reclassify the item to reflect a more masculine characteristic level.

In one embodiment, the adjusted characteristic levels of an item are not saved (associated with the item) in the database until some threshold number of users indicates that the level should be changed. In another embodiment, if some number of users indicate that a level should be changed, but the level of recommendations provided by the users vary drastically (e.g., they are not within some defined tolerance of each other), the characteristic level may not be adjusted until a certain number of users agree that the level should be a level within the threshold. In yet another embodiment, the level is adjusted in the database as soon as a first user indicated an adjustment to the level. Machine learning algorithms may also be employed to determine when to adjust an associated characteristic level and by how much. In one embodiment, item provider 215 may provide the search results and the user interface elements that allow users to make adjustments to characteristic levels, as described herein.

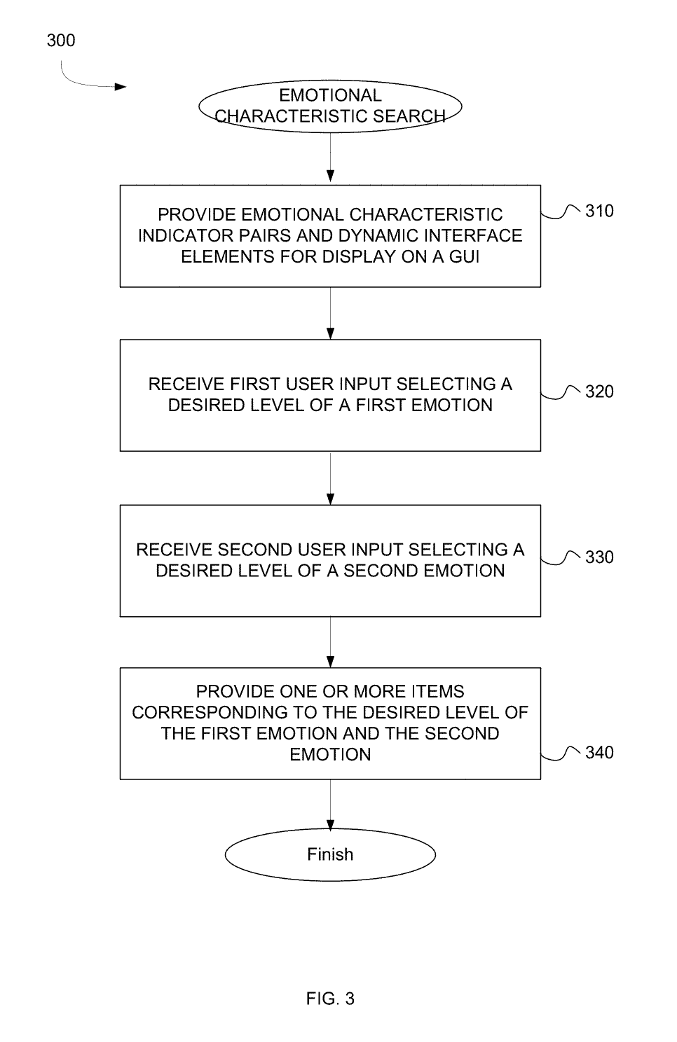

FIG. 3 is a flow diagram illustrating a method for an emotional characteristic search, according to an implementation. The processing flow method 300 may be performed by processing logic that comprises hardware (e.g., circuitry, dedicated logic, programmable logic, microcode, etc.), software (e.g., instructions run on a processing device to perform hardware simulation), or a combination thereof. Method 300 can provide an interface for, and perform a search based on emotional characteristics. In one embodiment, emotional characteristic search unit 110 may perform method 300.

Referring to FIG. 3, at block 310, processing logic provides emotional characteristic indicator pairs and interface elements for display on a graphical user interface (GUI). Each of the interface elements may be associated with a single emotional characteristic indicator pair of the emotional characteristic indicator pairs provided to the GUI.

At block 320, processing logic may receive first user input selecting, via a first interface element, a desired level of first emotion from emotions represented by a first pair of the plurality of emotional characteristic indicator pairs. The desired level of the first emotion may be selected via an interface element associated with the emotional characteristic indicator pair of the first emotion.

Processing logic may receive, at block 330, a second user input selecting, via a second interface element, a desired level of second emotion from emotions represented by a second pair of the plurality of emotional characteristic indicator pairs. In one embodiment, the first emotion and the second emotion are represented by two different emotional characteristic indicator pairs, where each pair represents a single pair of two opposing emotions.

Based on the received levels of the first emotion and the second emotion, processing logic at block 340 may provide one or more items corresponding to the desired level of first emotion and the desired level of second emotion. Items provided may be the result of searching a database for items associated with the desired levels and ranking the search results to be displayed on a GUI.

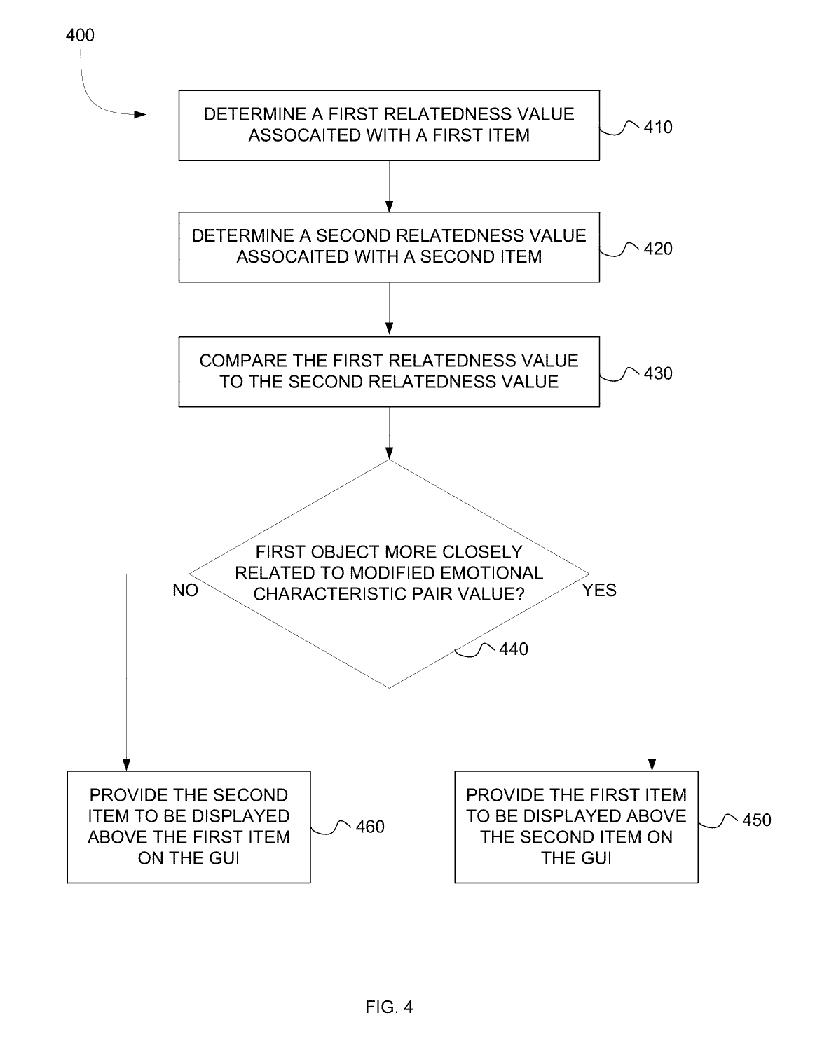

FIG. 4 is a flow diagram illustrating a method for ranking search results of an emotional characteristic search, according to an implementation. The processing flow method 400 may be performed by processing logic that comprises hardware (e.g., circuitry, dedicated logic, programmable logic, microcode, etc.), software (e.g., instructions run on a processing device to perform hardware simulation), or a combination thereof. Method 400 can provide an interface for, and perform a search based on emotional characteristics. In one embodiment, emotional characteristic search unit 110 may perform method 400.

At block 410, processing logic determines a relatedness value associated with a first item of a search result. The relatedness value may be a value that is based on how closely related the item is to desired emotional characteristic levels. For example, if a desired happy-sad level is 25, and a desired femininity-masculinity level is 75, an item with exactly those characteristic levels may have a maximum relatedness value. In one embodiment, the maximum relatedness value may be 100. For example, the relatedness value may be equal to 100−Rₐ, where Rₐ is the average characteristic level delta of all characteristic levels specified. For example, if a user searches for an item that is 40% happy-sad and 40% feminine-masculine, an item that is 50% happy-sad and 60% feminine-masculine may have a relatedness value of 85 (100−((50−40)+(60−40))/2). In other embodiments, various other methods may be used to determine how closely an item related to multiple desired characteristic levels.

At block 420, a second relatedness value is determined for a second item of a search result. Processing logic may compare the first relatedness value to the second relatedness value at block 430, and determine that, based on the associated relatedness values, the first item is more related to the desired characteristic levels than the second item. The first item (the more related item) may be displayed above the second item on the GUI at block 450. Alternatively, if, based on the associated relatedness values, the second item is more related to the desired characteristic levels than the first item, the second item may be displayed above the first item at block 460. Furthermore, items that have a relatedness value less than some threshold relatedness value may not be provided in a search result.

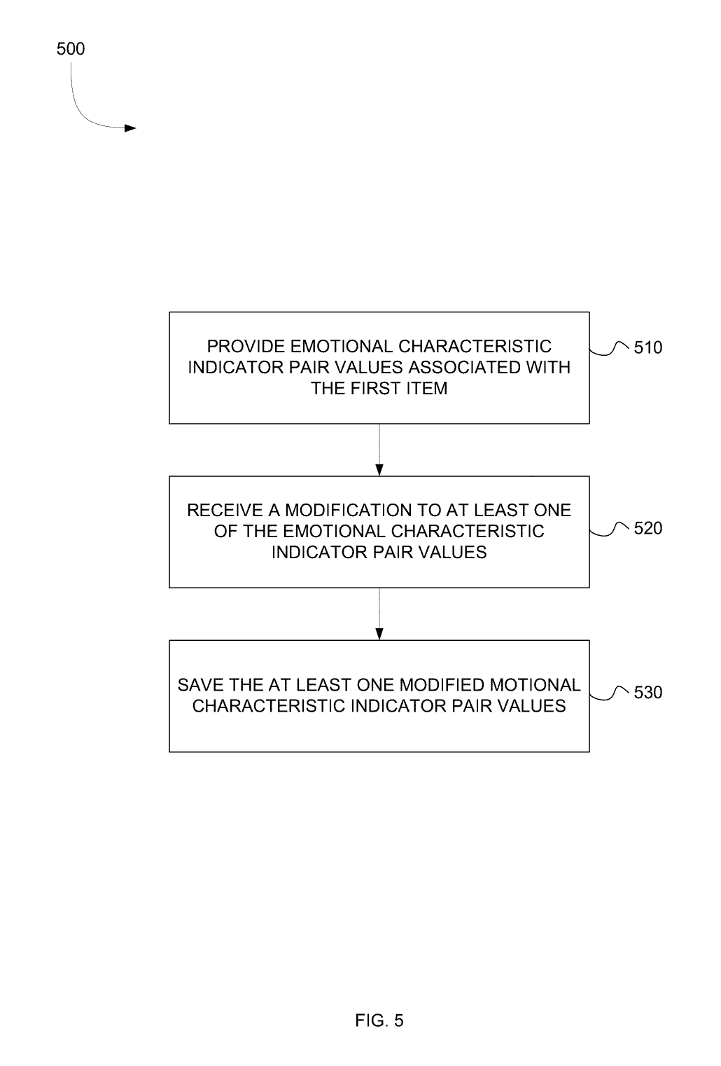

FIG. 5 is a flow diagram illustrating a method for modifying emotional characteristic indicator pair values, according to an implementation. The processing flow method 500 may be performed by processing logic that comprises hardware (e.g., circuitry, dedicated logic, programmable logic, microcode, etc.), software (e.g., instructions run on a processing device to perform hardware simulation), or a combination thereof. Method 500 can provide an interface for, and perform a search based on emotional characteristics. In one embodiment, emotional characteristic search unit 110 may perform method 500.

At block 510, processing logic provides emotional characteristic indicator pair values associated with a first item to be displayed on a GUI. In one embodiment, the values are display alongside their associated items in a search result. In another embodiment, a user may interact with an item of a search result (e.g., by clicking on it) to cause the emotional characteristic indicator pair values to be displayed.

At block 520, a modification to one or more levels associated with the item may be received. In one embodiment, a user may adjust the one or more levels by interacting with one or more interface elements (e.g., sliders) associated with the one or more levels.

At block 530, processing logic may save the adjusted one or more levels with the item. As discussed in further detail with respect to FIG. 2, the adjusted levels may not be saved until a threshold number of user adjustments has been met. In another embodiment, the adjusted levels may be saved immediately after the first adjustment.

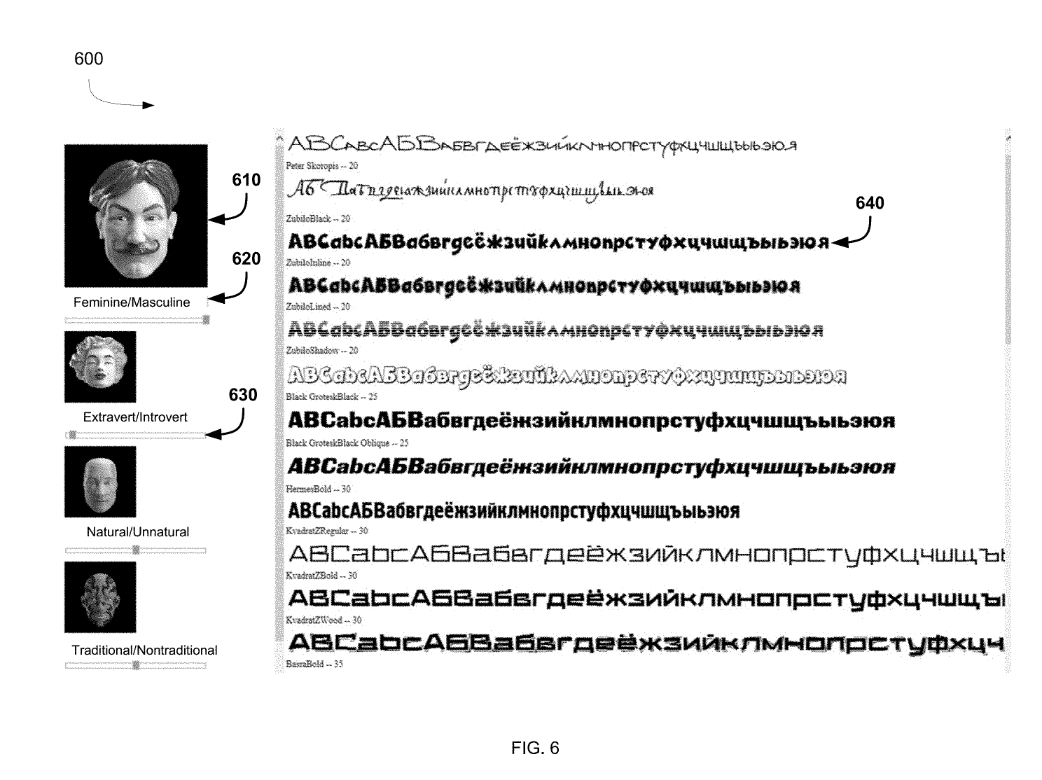

FIG. 6 is a block diagram illustrating an emotional characteristic search user interface 600, according to an implementation. GUI element 610 represents an emotional characteristic indicator, which is dynamically modified to illustrate the currently selected level of the associated emotional characteristic indicator pair. Emotional characteristic indicator pair 620 may be displayed via text (as shown) or by some other way (e.g., by displaying two images representing each emotion of the emotional characteristic pair). Interface element 630 can be interacted with, to select a desired level of emotion associated with the emotional characteristic indicator pair. Search results 640 may be dynamically displayed when a user selects or modifies a selection of a level associated with an emotional characteristic. Alternatively, a GUI element (e.g., a button) may be activated, before search results are displayed, to indicate that a user is done making selections and would like to see search results.

FIG. 7 illustrates a diagrammatic representation of a server 102 in the example form of a computing device within which a set of instructions, for causing the machine to perform any one or more of the methodologies discussed herein, may be executed. The server 102 may be in the form of a computing device (e.g., a server computer) within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example server 102 includes a processing device 702, a main memory 704 (e.g., read-only memory (ROM), flash memory, dynamic random access memory (DRAM) such as synchronous DRAM (SDRAM)), a static memory 706 (e.g., flash memory, static random access memory (SRAM)) and a data storage device 718, which communicate with each other via a bus 730.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application specific integrated circuit (ASIC), a field programmable gate array (FPGA), a digital signal processor (DSP), network processor, or the like. The processing device 702 is configured to execute emotional characteristic search logic 719 for performing the operations and steps discussed herein.

The server 102 may further include a network interface device 708 which may communicate with a network 720. The server 102 also may include a video display unit 710 (e.g., a liquid crystal display (LCD) or a cathode ray tube (CRT)), an alphanumeric input device 712 (e.g., a keyboard), a cursor control device 714 (e.g., a mouse) and a signal generation device 716 (e.g., a speaker). In one embodiment, the video display unit 710, the alphanumeric input device 712, and the cursor control device 714 may be combined into a single component or device (e.g., an LCD touch screen).

In one embodiment, data storage device 718 may represent storage device 120. The data storage device 718 may include a computer-readable medium 728 on which is stored one or more sets of instructions (e.g., instructions of module 722, such as an identifier module or a data store module) embodying any one or more of the methodologies or functions described herein. The module 722 may (e.g., an identifier module or a data store module) also reside, completely or at least partially, within the main memory 704 and/or within the processing device 702 during execution thereof by the server 102, the main memory 704 and the processing device 702 also constituting computer-readable media. The instructions may further be transmitted or received over a network 720 via the network interface device 708.

While the computer-readable storage medium 728 is shown in an example embodiment to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media and magnetic media.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “providing,” “receiving,” “determining,” “comparing,” “associating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a non-transitory computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth above are merely examples. Particular implementations may vary from these example details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
providing, for display on a graphical user interface (GUI), a plurality of emotional characteristic indicator pairs and a plurality of interface elements, each of the plurality of interface elements being associated with an emotional characteristic indicator pair of the plurality of emotional characteristic indicator pairs;
receiving, by a processing device, first user input selecting, via a first interface element of the GUI, a desired level of first emotion from emotions represented by a first pair of the plurality of emotional characteristic indicator pairs;
receiving second user input selecting, via a second interface element of the GUI, a desired level of second emotion from emotions represented by a second pair of the plurality of emotional characteristic indicator pairs; and
in response to the first user input and the second user input, providing one or more items corresponding to the desired level of first emotion and the desired level of second emotion.

2. The method of claim 1, further comprising:
determining a first relatedness value associated with a first item of the one or more items and a second relatedness value associated with a second item of the one or more items, the first and second items corresponding to the desired level of the first emotion and the desired level of the second emotion;
comparing the first relatedness value to the second relatedness value;
determining, based on the comparison, that the first item is more closely related to the desired level of the first emotion and the desired level of the second emotion than the second item; and
based on the determination that the first item is more closely related to the desired level of the first emotion and the desired level of the second emotion than the second item, providing the first item to be displayed above the second item on the GUI.

3. The method of claim 1, further comprising:
providing the plurality of emotional characteristic indicator pair values related to a first item of the one or more items to be displayed on the GUI;
receiving a modification to at least one of the plurality of emotional characteristic indicator pair values related to the first item; and
associating the modified at least one of the plurality of emotional characteristic indicator pair values with the first item in a database.

4. The method of claim 1, further comprising:
providing a modified emotional characteristic indicator to be displayed on the GUI, the modified emotional characteristic indicator corresponding to the desired level of the first emotion.

5. The method of claim 1, wherein the one or more items are stored in a database, and wherein each of the one or more items stored in the database is associated with one or more of the plurality of emotional characteristic indicator pairs.

6. The method of claim 1, wherein the desired level of the first emotion is based on a proportion of each of the first pair of the plurality of emotional characteristic indicator pairs.

7. The method of claim 1, wherein the one or more items corresponding to the desired level of first emotion and the desired level of second emotion are provided in response to determining that each of the one or more items has a relatedness value that is less than a threshold relatedness value.

8. A system, comprising:
a memory to store a plurality of emotional characteristic indicator pairs and a plurality of interface elements; and
a processing device, operatively coupled to the memory, the processing device to:
provide, for display on a graphical user interface (GUI), a plurality of emotional characteristic indicator pairs and a plurality of interface elements, each of the plurality of interface elements being associated with an emotional characteristic indicator pair of the plurality of emotional characteristic indicator pairs;
receive first user input selecting, via a first interface element of the GUI, a desired level of first emotion from emotions represented by a first pair of the plurality of emotional characteristic indicator pairs;
receive second user input selecting, via a second interface element of the GUI, a desired level of second emotion from emotions represented by a second pair of the plurality of emotional characteristic indicator pairs; and
in response to the first user input and the second user input, provide one or more items corresponding to the desired level of first emotion and the desired level of second emotion.

9. The system of claim 8, wherein the processing device is further to:
determine a first relatedness value associated with a first item of the one or more items and a second relatedness value associated with a second item of the one or more items, the first and second items corresponding to the desired level of the first emotion and the desired level of the second emotion;
compare the first relatedness value to the second relatedness value;
determine, based on the comparison, that the first item is more closely related to the desired level of the first emotion and the desired level of the second emotion than the second item; and
based on the determination that the first item is more closely related to the desired level of the first emotion and the desired level of the second emotion than the second item, provide the first item to be displayed above the second item on the GUI.

10. The system of claim 8, the processing device further to:
provide the plurality of emotional characteristic indicator pair values related to a first item of the one or more items to be displayed on the GUI;
receive a modification to at least one of the plurality of emotional characteristic indicator pair values related to the first item; and
associate the modified at least one of the plurality of emotional characteristic indicator pair values with the first item in a database.

11. The system of claim 8, the processing device further to:
provide a modified emotional characteristic indicator to be displayed on the GUI, the modified emotional characteristic indicator corresponding to the desired level of the first emotion.

12. The system of claim 8, wherein the one or more items are stored in a database, and wherein each of the one or more items stored in the database is associated with one or more of the plurality of emotional characteristic indicator pairs.

13. The system of claim 8, wherein the desired level of the first emotion is based on a proportion of each of the first pair of the plurality of emotional characteristic indicator pairs.

14. The system of claim 8, wherein the processing device is further to:
determine that each of the one or more items has a relatedness value that is less than a threshold relatedness value; and
provide the one or more items corresponding to the desired level of first emotion and the desired level of second emotion in response to the determination.

15. A non-transitory machine-readable storage medium including instructions that, when accessed by a processing device, cause the processing device to:
provide, for display on a graphical user interface (GUI), a plurality of emotional characteristic indicator pairs and a plurality of interface elements, each of the plurality of interface elements being associated with an emotional characteristic indicator pair of the plurality of emotional characteristic indicator pairs;
receive first user input selecting, via a first interface element of the GUI, a desired level of first emotion from emotions represented by a first pair of the plurality of emotional characteristic indicator pairs;
receive second user input selecting, via a second interface element of the GUI, a desired level of second emotion from emotions represented by a second pair of the plurality of emotional characteristic indicator pairs; and
in response to the first user input and the second user input, provide one or more items corresponding to the desired level of first emotion and the desired level of second emotion.

16. The non-transitory machine-readable storage medium of claim 15, wherein the processing device is further to:
determine a first relatedness value associated with a first item of the one or more items and a second relatedness value associated with a second item of the one or more items, the first and second items corresponding to the desired level of the first emotion and the desired level of the second emotion;
compare the first relatedness value to the second relatedness value;
determine, based on the comparison, that the first item is more closely related to the desired level of the first emotion and the desired level of the second emotion than the second item; and
based on the determination that the first item is more closely related to the desired level of the first emotion and the desired level of the second emotion than the second item, provide the first item to be displayed above the second item on the GUI.

17. The non-transitory machine-readable storage medium of claim 15, the processing device further to:
provide the plurality of emotional characteristic indicator pair values related to a first item of the one or more items to be displayed on the GUI;
receive a modification to at least one of the plurality of emotional characteristic indicator pair values related to the first item; and
associate the modified at least one of the plurality of emotional characteristic indicator pair values with the first item in a database.

18. The non-transitory machine-readable storage medium of claim 15, the processing device further to:
provide a modified emotional characteristic indicator to be displayed on the GUI, the modified emotional characteristic indicator corresponding to the desired level of the first emotion.

19. The non-transitory machine-readable storage medium of claim 15, wherein the desired level of the first emotion is based on a proportion of each of the first pair of the plurality of emotional characteristic indicator pairs.

20. The non-transitory machine-readable storage medium of claim 15, wherein the processing device is further to:
determine that each of the one or more items has a relatedness value that is less than a threshold relatedness value; and
provide the one or more items corresponding to the desired level of first emotion and the desired level of second emotion in response to the determination.
